(19) United States
(12) Patent Application Publication
(10) Pub. No.: US 2013/0302015 A1
(43) Pub. Date: Nov. 14, 2013

(54) Method of Acquisition, Storage and Use of Data Relating to a Three-Dimensional Video Stream, and Video Processing Apparatus Thereof

(71) Applicants: Roberto Dini, None (IT); Saverio Celia, Rivalta Di Torino (IT)

(72) Inventors: Roberto Dini, None (IT); Saverio Celia, Rivalta Di Torino (IT)

(73) Assignee: S.I.SV.EL SOCIETA ITALIANA PER LO SVILUPPO DELL'ELETTRONICA S.P.A., None(TO) (IT)

(21) Appl. No.: 13/980,848

(22) PCT Filed: Feb. 13, 2012
(86) PCT No.: PCT/IB12/50643

§ 371 Date: Jul. 19, 2013

(30) Foreign Application Priority Data
Feb. 15, 2011 (IT) TO2011A000128

(51) Int. Cl. H04N 13/00

(52) U.S. Cl. CPC H04N 13/0055
USPC 386/248

(57) ABSTRACT

A method for acquiring and storing data relating to video streams selectable on a video processing apparatus adapted to select a video stream reproducible on an associated reproduction device includes: identifying the source of the video stream by identification data, the video stream having a coding and transport configuration adapted to produce a three-dimensional display; verifying if, for the identified video stream, any data relating to the coding and transport configuration of the video stream are stored by the video processing apparatus in storage of the video processing apparatus including associations between video stream identification data and video stream coding and transport configurations; when affirmative, acquiring from the storage the coding and transport configuration associated with the video stream identified by the identification data, and using the data for a following selection of the video stream in order to reproduce the selected video stream on an associated video reproduction device.

### DESCRIPTION

The present invention relates to a video processing method and apparatus used in the field of video image reception and capable of reproducing a three-dimensional display.

More in particular, the invention relates to a method of acquisition and storage of data relating to the format of a video image stream adapted to be reproduced in three-dimensional mode, as well as to a video processing apparatus.

It is known that, in order to be able to exploit the three-dimensional effect introduced by binocular vision, it is necessary to provide a user's left eye and right eye with a device capable of reproducing the corresponding left and right images in a three-dimensional stream. In stereoscopic systems, this is done by transmitting both images in a single video stream, which therefore contains, for each frame of the scene, both the left image and the right image.

Numerous formatting techniques are currently in use for coding, transporting and distributing stereoscopic video streams depending on the different modes in which the images of the stereoscopic pair are represented. In a certain class of such formats, the left and right images of the frames that make up the video stream are placed into the same frame (“frame packing”), so as to allow for the distribution of stereoscopic video streams within distribution systems already in use for the circulation of two-dimensional contents, more precisely High Definition (HD) contents. Said frame packing techniques are differentiated on the basis of parameters such as, for example, size, rotation, decimation or undersampling, representation, layout and frequency of transfer of the two images within the video stream. Among others, we can mention the “side by side” technique, wherein the two left and right images are placed into the same frame by halving the horizontal resolution value of each image, and the “top-bottom” technique, wherein the two left and right images are placed into the same frame, called composite frame, by halving the vertical resolution value of each image in accordance with various decimation or undersampling techniques.

According to a further technique used for arranging the two images, one of them is placed without being fragmented into a composite frame, while the other one is suitably broken up into several parts and placed into the frame space left empty by the first image. This type of configuration of the stereoscopic video stream will hereafter be referred to as “fragmented”.

For coding efficiency reasons, other techniques have also been proposed such as, for example, the “L+depth” technique, consisting of transmitting the left image plus a depth map. By combining these two pieces of information, the display apparatus can rebuild the three-dimensionality of the scene, obtaining the right image from the left one and from the depth map. Other similar techniques have also been proposed, which exploit the strong correlation between the two left and right images, such as, for example, the so-called “2D+Delta” coding.

Among the other techniques known in the art, it is worth mentioning the so-called “field alternative”, “line alternative”, “column alternative” and “L+depth+graphics+graphics-depth” techniques.

The above list of coding techniques is not exhaustive, because such techniques are continually evolving with the aim of improving the definition of the three-dimensional image, while trying to keep the video stream within certain limits of band occupation.

Each one of these frame packing, coding and display techniques has advantages and drawbacks, and may conjugate to the other ones in a more or less optimal manner. At any rate, such a variety of three-dimensional content representation and display techniques creates many content coding and transport configurations, resulting in the necessity of being able to recognize them in order to adapt the video stream to different three-dimensional reproduction techniques on a display apparatus (e.g. a screen or a projector).

This variety of coding and transport configurations is flanked by an increased production of three-dimensional contents, which are distributed in multiple forms, e.g. by storing them on Blu-ray and DVD media, by transmitting them through broadcast coding and transport channels (satellite, cable or terrestrial), or by making them available for download from local area networks or geographic area networks, such as the Internet.

At present, there is no unified technique or reference standard for transmitting and displaying a three-dimensional video content in all environments of production, distribution and visualization of stereoscopic video contents. Also, there is no reference standard for signalling, within the video stream, the coding and transport configuration adopted to produce a three-dimensional effect which applies to all production, distribution and fruition environments, independently of the source (e.g. TV broadcaster, Blu-ray disk, Internet site), of the coding and transport means (optical or electronic medium, air, cable, satellite) and of the display device (e.g. with “frame alternation”, or with alternated rows or columns). Said signalling is useful for the display apparatus, which otherwise cannot properly interpret the video stream to be reproduced, unless costly and sophisticated video stream analysis algorithms are used, which algorithms require many software and/or hardware resources (which could be used for other purposes) and much time for their full execution.

In addition, video stream players and/or receivers may be fitted with numerous interconnection interfaces, e.g. DVI, HDMI, Display Port, USB, WiMAX, Wi-Fi, and of course may include built-in television tuners and Blu-ray or DVD readers and solid-state or optical electronic memories.

Each of these video streams or contents may adopt a different configuration for the coding and transport of the three-dimensional content to be displayed, possibly on the same display device. It may therefore be necessary, or at least appropriate, to support different configuration of the input stereoscopic video stream in one display device, which normally uses a display format of its own, different from the one (called “configuration” herein) used for coding and transport, so that a format conversion is required. Three-dimensional content reproduction apparatuses are available on the market which are fitted with suitable graphic control interfaces or selectors on control units, through which the user must every time manually select the specific coding and transport configuration adopted by the received three-dimensional video stream to be represented, so as to ensure a correct three-dimensional reproduction thereof on the associated display device.

In this context, the term “video stream” refers to a series of video frames, each containing one or more images or video data. The term “video data” refers to data containing information about the video content of the frames, e.g. a depth map in the case of the “L+depth” configuration. The decompressed images and video data contained in said frames have their own coding and transport configuration, which must be known to the display device for said images and video data to be reproduced correctly.

The above-described technology scenario is extremely complex and variegated, due to the high degree of complexity reached by players and/or receivers, to the numerous possible coding and transport configurations which are constantly in evolution, and to the absence of any unified reference standards for signalling and recognizing three-dimensional contents. It may thus happen that the coding and transport configuration of the three-dimensional video stream is not signaled in time or is not signalled at all, or that it is decided at the last instant and/or communicated separately from the signal, e.g. in a television program guide magazine.

Such a concrete situation may arise, for example, when video contents are broadcast through radio-television signal transmission systems in which there are different three-dimensional content signalling data for services distributed by the same radio-television broadcaster (e.g. RAI). For instance, a first service “RaiUno” may use three-dimensional contents having a different configuration than a second service “RaiDue”, or a given program transmitted by the service “RaiUno” may use three-dimensional contents configured according to the “side by side” technique, whereas the next program, still belonging to the service “RaiUno”, may use a “top-bottom” configuration. In both cases, the signalling data might not be correct or updated accordingly, e.g. due to insufficient personnel or economical resources, or to the absence of apparatuses specifically used for that purpose.

This may happen because, for example, for economic or logistic reasons a provider of three-dimensional video contents handles contents characterized by different coding and transport configurations, in that they come from production sources that exclusively utilize one of the possible coding and transport configurations, and converting all contents into one format is considered to be too expensive. It is also possible that the same video content provider can produce video contents in only a limited number of the possible coding and transport configurations, whether to limit expenditure or for logistic or engineering reasons.

Moreover, it may also be the case that, even within the same television service, some particular programs (e.g. movies, live sports events) are broadcast in 3D mode, while other programs are broadcast in 2D mode on the same digital television service (e.g. “RaiUno”).

In both the above circumstances, during zapping, i.e. when repeating in cascade within a short period of time a series of selections of different television services characterized by video streams having generally different configurations, the television receiver must switch between different coding and transport configurations in order to adapt the visualization of the different video streams to the same display device associated with the receiver. This implies a certain delay in the proper reproduction of the video stream of the television service just selected; therefore, it may happen that the video stream just selected is temporarily reproduced in a wrong way, until the change in the coding and transport configuration has been acquired and the new video stream has been accordingly adapted to the 3D reproduction format used by the display device.

As a palliative solution, one may interrupt the video reproduction or freeze the display on said device until switching has occurred, but the user will still be annoyed to wait some time for the reproduction to be adapted to the last television service selected.

It is one object of the present invention to provide a method of acquisition and storage of data relating to a three-dimensional video stream, as well as a related video processing apparatus, which allow speeding up the reproduction of a video stream in accordance with the correct coding and transport configuration.

It is another object of the present invention to provide a method of acquisition and storage of data relating to the configuration taken by a three-dimensional video stream, as well as a related video processing apparatus, which allow the user to handle the processing of three-dimensional video streams in a simple and immediate manner, independently of the many possible coding and transport configurations that the video stream may have.

It is a further object of the present invention to provide a method of acquisition and storage of data relating to a three-dimensional video stream, as well as a related video processing apparatus, which allow minimizing the operations to be carried out by a user in order to obtain a proper reproduction of a three-dimensional video stream.

In short, the present invention relates to a method and a device for acquiring and storing data relating to user-selectable video streams, wherein said video streams have a certain coding and transport configuration for producing a three-dimensional display. The device comprises a memory that stores identification data identifying the user-selectable video streams, configuration data identifying the video stream coding and transport configurations, and the association between the video stream identification data and the video stream coding and transport configuration data. Every time the user selects a certain video stream identified by one of the stream identification data, the device verifies if a coding and transport configuration has been stored for the selected video stream and can use it immediately to perform a correct reproduction thereof on an associated display device. Then the device can verify if the video stream being reproduced contains respective configuration data; if there are, it can apply these configuration data for reproducing the stream on the associated display device.

Subsequently, when a three-dimensional video stream already stored in accordance with the method of the present invention is recalled, the display device does not have to immediately extract the coding and transport configuration from the video stream itself before appropriately converting it into a format that can be properly reproduced by an associated display device, since it can simply and quickly read the coding and transport configuration from a memory with access times much shorter than those necessary for extracting it from a special metadatum included in the stream.

In the case of a video content present in a file or another multimedia logic medium that contains no indication about the coding and transport configuration, the user needs not enter again said configuration manually at the next selection of the same file for reproducing it on a screen or another display device.

Further features and objects of the invention will be set out in the appended claims, which are intended as an integral part of the present description; the teachings of the invention will become more apparent from the following detailed description of a preferred but non-limiting example of embodiment thereof with reference to the annexed drawings, wherein:

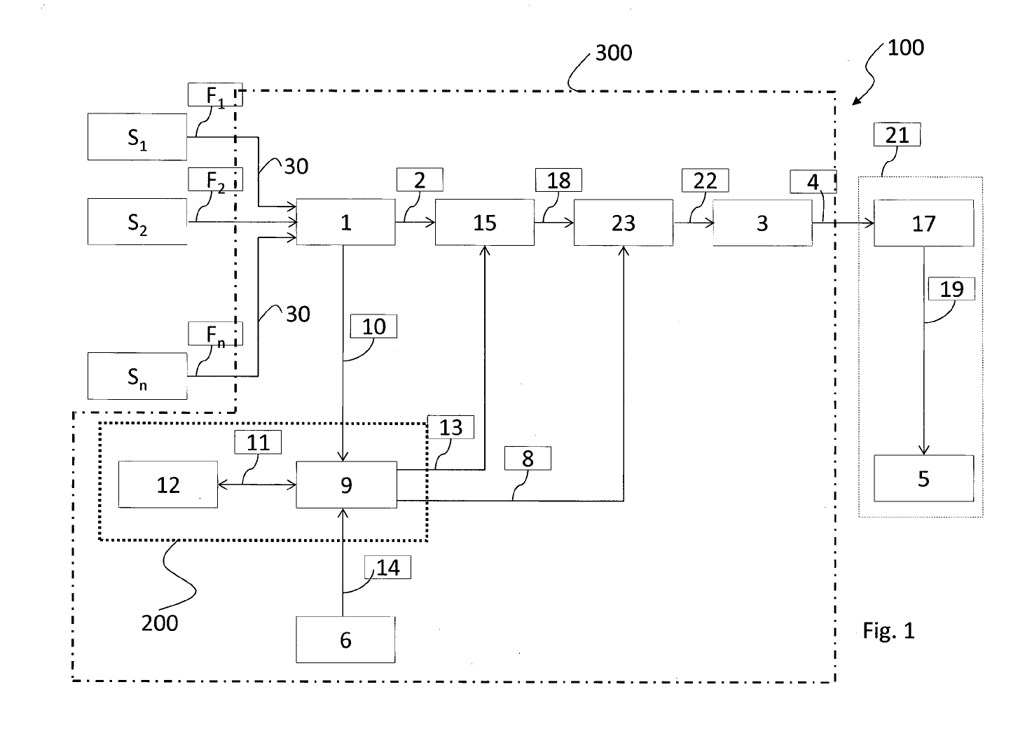

FIG. 1 is a block diagram of an apparatus for reproducing two-dimensional and three-dimensional contents;

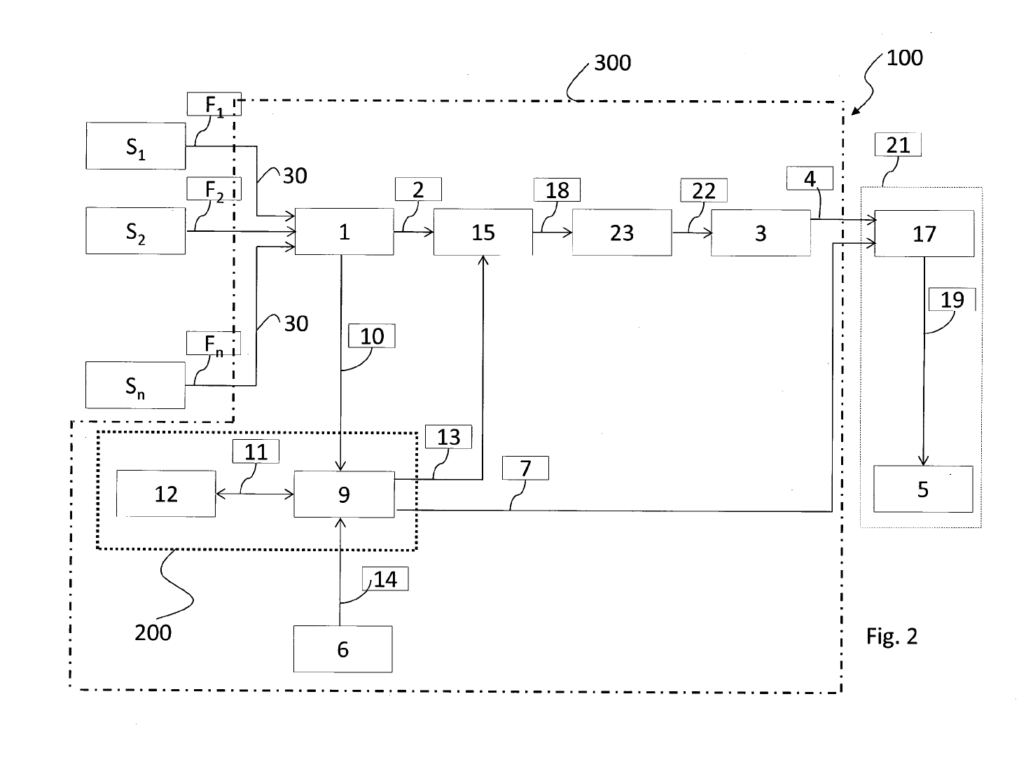

FIG. 2 is a block diagram of a reproduction system which is alternative to the one shown in FIG. 1;

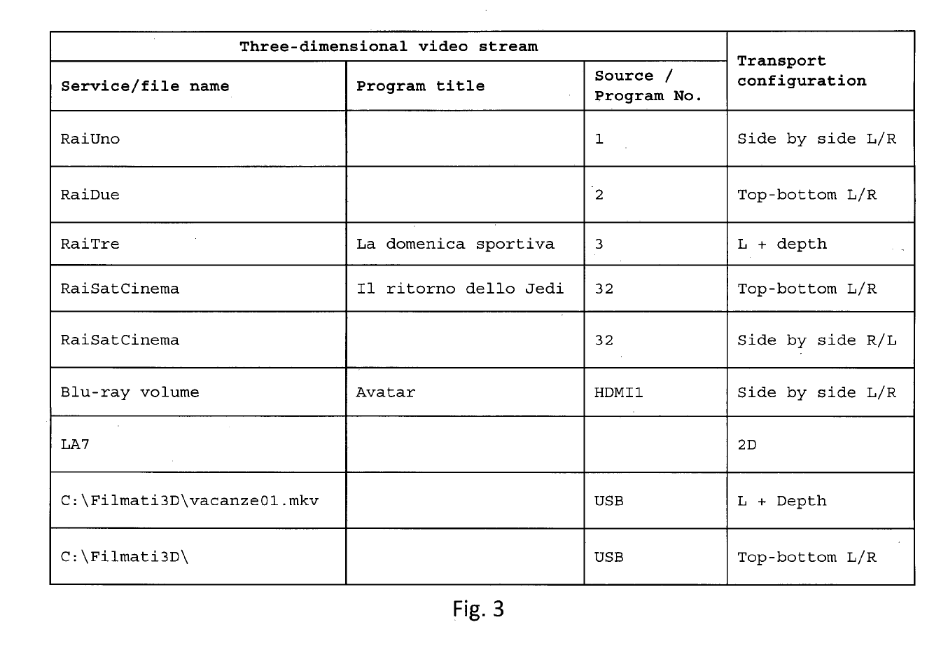

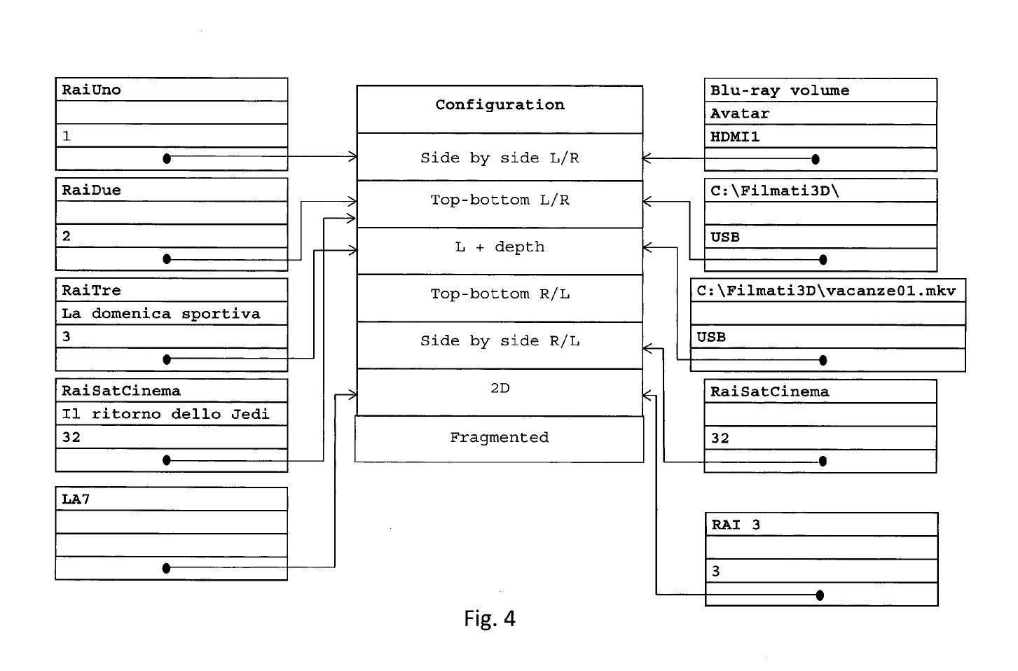

FIGS. 3 and 4 respectively show a first and a second embodiments of a data structure that can be stored in a device according to the present invention;

FIG. 5 shows an implementation of a data structure that can be stored in a device according to the present invention;

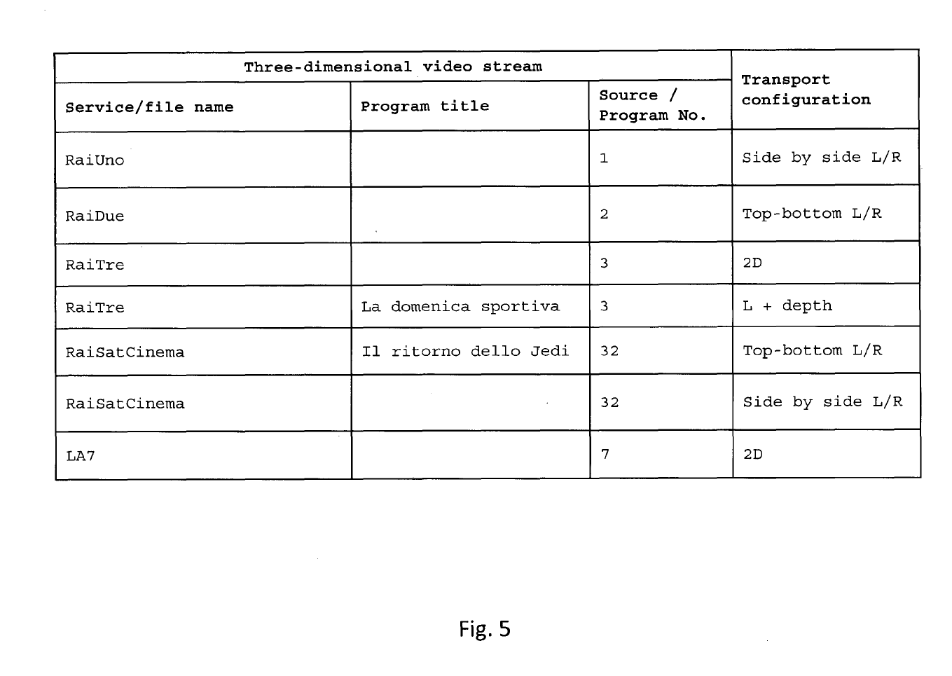

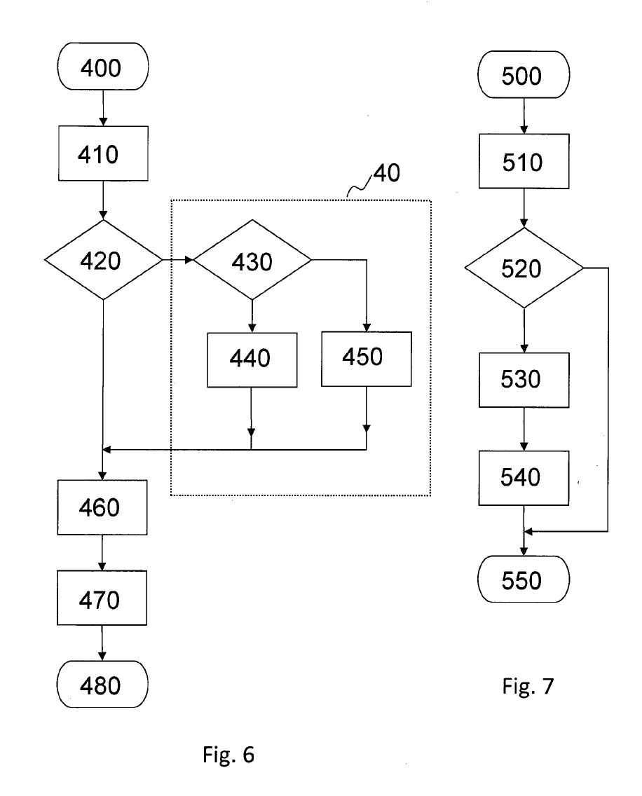

FIGS. 6 and 7 are flow charts of data acquisition and processing method according to the present invention.

With reference to FIG. 1, there is shown a system 100 for acquiring and reproducing three-dimensional (and also two-dimensional) contents, which comprises:
a plurality of sources S₁, . . . Sₙ of three-dimensional signals (as well as two-dimensional signals), wherein said sources Sn may, for example, take the form of readers or Blu-ray/DVD disks, tuners for receiving broadcast television transmissions, memory readers using the USB interface, electronic memories (USB, flash disk, hard disk, solid-state) or optical memories, wireless interfaces, Ethernet cables, and the like;
a decoder 1, which acquires and decodes the data supplied by a source Si; said sources can be associated, generally one at a time, with the decoder 1 through a selection multiplexer device, not shown in the drawing;
a video processor 15, adapted to enter specific graphic interfaces into a video stream;
a display apparatus 21 comprising a display device 5, adapted to display at least the video stream, and a display control unit 17, adapted to handle the activity of the display device 5. The display device 5 may be a screen of any type, e.g. LCD, plasma, back-projection or a video projector; in general, it may consist of any apparatus adapted to reproduce the images of a video stream in a form that can be perceived by the human eye;
a data interface 3, adapted to supply the display apparatus 21 with data useful for displaying the video stream;
a control unit 23 for controlling the data interface 3, adapted to handle the activity of the data interface 3;
storage means 12, consisting of one or more memory areas, whether of the volatile or non-volatile type, adapted to store tables and other data structures;
a control module 9, adapted to output data useful for displaying three-dimensional and two-dimensional video streams;
a control unit 6, which outputs signals to the control module 9 in response to an operation executed by a user: the control unit 6 may be implemented in various manners, e.g. through a plurality of keys, a remote control and the like, so as to allow a user to select functions and issue commands.

The apparatus 300 may be, for example, a television set, a set-top box, a video recorder, a cellular telephone, etc., and has the capability of acquiring and processing three-dimensional video contents. It must be pointed out that, at any rate, for the purposes of the present invention the display apparatus 21 may not be built in a video processing apparatus 300, but associated therewith or connected thereto through known connection means or data interfaces, whether wired (e.g. HDMI, DVI, Display port, SCART, RCA-Cinch) or wireless. When the display apparatus 21 is built in the apparatus 300, the interface may take the form of an internal data bus of the apparatus 300. In this latter case it is conceivable, as an alternative, that the control module 9 has a fifth output 7, directly connected to the display control unit 17, as shown in FIG. 2. The teaching of the present invention can be implemented regardless of the presence or absence of the display apparatus 21. The apparatus 300 comprises a processing device 200 that comprises the control module 9, the storage means 12 and means 10 for acquiring data identifying a video stream having a coding and transport configuration adapted to produce a three-dimensional display and data identifying said coding and transport configuration.

The source Sᵢ acquires a three-dimensional video content and sends it over a data line 30, in the form of a coding and transport stream Fᵢ, to the decoder 1. In this context, the term “coding and transport stream” refers to a stream of information containing the data of a compressed or decompressed video stream and a set of metadata relating to that video stream, adapted to be transported on a specific coding and transport means. Each one of the sources S₁, . . . Sn provides a coding and transport stream F₁, . . . , Fₙ through a corresponding data line 30.

In particular, the coding and transport stream Fᵢ present on the data line 30 includes a set of metadata which, among other information, may also contain information that identifies the source and/or the content of the video stream.

These identification data may be partially integrated with information added by the apparatus 300, such as, for example, the program number under which a given video stream received by a TV tuner has been stored or the identifier of the communication port (SCART, USB, AV1, EXT1, DVI, HDMI1, HDMI2 and the like) where the video stream is in transit.

In the case of a coded video stream, the decoder 1 can decompress the data relating to the compressed video stream, contained in the coding and transport stream Fᵢ supplied by the data line 30, or anyway it can extract the video stream Fᵢ from the generic coding and transport stream Fᵢ supplied by the generic data line 30, and send the same video stream to the video processor 15 through a first output 2. At the first output 2 of the decoder 1 a video stream is thus obtained which contains the images packed into the transport stream. Fᵢ supplied by the data line 30. The images take a particular coding and transport configuration within the video stream Fᵢ, so as to produce, on the display device 5, a visualization having the purpose of creating a three-dimensional effect.

The control module 9 controls the activity of the video processor 15 through a second output 13, based on the value of which the video processor 15 will operate in different modes.

In a first mode of operation, the video processor 15 simply outputs the video stream. In a second operating mode, the video processor 15 processes the contents of the video stream so as to obtain a modified video stream containing a suitable graphic interface intended for the user. The video stream or the modified video stream containing the graphic interface are sent through a connection 18 to the data interface control unit 23. The control unit 23 sends to the data interface 3, through a third output 22, a coding and transport stream adapted to be transported over the data interface 3 and containing the video stream. A video stream coding and transport configuration value is entered into the metadata of the coding and transport stream, said configuration being sent to the control unit 23 through a fourth output 8 of the control module 9. The coding and transport stream is then sent, through the data interface 3, to the display apparatus 21, in particular to the display control unit 17, which processes said coding and transport stream so as to provide the display device 5 with a display format compatible with the display device 5 itself.

In both operating modes of the video processor 15, it is conceivable that the control module 9 sends through the second output 13, in response to the selection of a video stream or anyway to a suitable command issued by the user, a signal containing the coding and transport configuration value of the selected video stream to the video processor 15, which then enters, in a graphic form recognizable by the user, the information about the coding and transport configuration value into the images that make up the selected video stream. In this way, the user can read the coding and transport configuration of the selected video stream on the display device 5.

The decoder 1 extracts the metadata containing the information identifying the source of the three-dimensional video content, possibly associated with other data previously associated therewith by the apparatus 300 or otherwise obtainable from the latter (e.g. from the program number, the service name, the file name and/or size or from the source port).

The control module 9 receives the metadata through the means 10 for acquiring video stream identification data, and extracts from said metadata the identification data of the video stream. In the case of coding and transport streams coming from television broadcasters, each television broadcaster has its own identification code for each distributed service or program. For example, in the case of digital terrestrial broadcasting, said identification code is the LCN information (“Logic Channel Number”), which is used by suitable television receivers for the purpose of automatically assigning to the service being received a predefined position in the list of received services. As a service identifier, one may even use an identifier of the video content of the service involved, e.g. the PID (Packet Identifier) that characterizes the elementary stream associated with a given video stream of an MPEG transport or program stream. Even the single program title, transmitted within the television channel or service, is signalled through suitable identification codes, like the EIT tables of the DVB standard, contained in the MPEG-2 Transport Stream. In the extreme case wherein a certain broadcaster always broadcasts stereoscopic video streams having the same configuration, one may even store into a table, shown in FIG. 3, only the program number under which said service was stored into the program table by the apparatus 300, so that it can be selected by the user for subsequent selection and for playback by, for example, entering the corresponding program number by using the numeric keys of the control unit 6 or the up/ down keys for incrementing and decrementing the program number (“zapping”).

Similar considerations also apply to coding and transport streams coming from other types of sources Si, e.g. from a solid-state memory medium, like a USB key, or an optical memory medium, such as a Blu-ray/DVD reader (if the receiver apparatus is provided with a USB interface or a Blu-ray/DVD reader), wherein the metadata include information about the file name, the file content and the file location in the memory medium.

FIG. 3 shows a data structure comprising at least the following fields: service or file name, program or file title, program source or number, and coding and transport configuration. The usefulness of said data structure will be further explained later on.

Once the video stream identification datum has been acquired, the control module 9 verifies if in the storage means 12, to which it is connected through a data exchange line 11, a configuration datum, which identifies the coding and transport configuration of the images belonging to the stream itself, has already been associated with said three-dimensional video stream identification datum. If it has, the configuration identified by the configuration data is automatically supplied, through the fourth output 8 of the control module 9, to the control unit 23 of the data interface 3, as shown in FIG. 1. The three-dimensional video stream can thus be displayed correctly, since the signal sent to an input 4 of the display device 21 comprises both the video stream and the coding and transport configuration associated therewith through the control module 9. As an alternative, the configuration identified by the configuration datum may be automatically supplied, through the fifth output 7, directly to the display control unit 17, as shown in FIG. 2. In short, the data relating to the coding and transport configuration can be immediately used for reproducing the video stream selected by the user, without having to be obtained otherwise, e.g. by extrapolating them from one or more metadata contained in the video stream itself, through an analysis of the video content, or by requesting them to the user.

FIG. 6 illustrates in detail the method according to the present invention. When the user selects a video stream (e.g. a television service, an AVI video file, a video on a DVD or Blu-ray medium), the device 200 begins (block START 400) to acquire, at step 410, the identification data adapted to identify the selected video stream, which data may vary depending on the type of video stream. At step 420 it is verified if the storage means 12 are storing data relating to the coding and transport configuration of the video stream identified at step 410. In the affirmative case, the device 200 acquires from the storage means 12 such data relating to the coding and transport configuration and outputs them (block 460) to the video processing device 300, which can then use them (block 470) for reproducing the selected video stream on an associated display device 5.

The operations carried out in the event that no association is found in the storage means 12 between the selected video stream and the respective coding and transport configuration (framed area 40 in FIG. 6) are wholly unessential for the purposes of the present invention. By way of example, however, it is conceivable to verify (block 430) if a coding and transport configuration can be obtained from the selected video stream. In the affirmative case, such configuration is obtained and stored into the memory 12 (block 440). If not, the user may be required to manually enter said configuration with the help of a suitable graphic interface or through interactive dialog (block 450); the entry is then stored into the storage means 12.

As an alternative to the above operations, one may even just associate with the selected video stream and store into the storage means 12 a default configuration, e.g. “no 3D configuration”, corresponding to “2D format”. A possible association with a different configuration is left up to the user at a later time, in that the user may advantageously be allowed to modify the associations stored in the storage means 12, e.g. by first entering a password.

Once the data relating to the configuration required for a correct three-dimensional reproduction of the selected video stream have been acquired, for increased safety it is possible to verify the exactness thereof starting from the selected video stream, e.g. by verifying if it includes data relating to its coding and transport configuration in the form of metadata. In fact, for video streams corresponding to television services, it may happen that, following modifications to the program schedule or technologic updates, the service provider has changed the transport configuration used for a given service or for a particular program or set of programs or video contents which are being broadcast over a given TV service.

Let us assume that, for example, from a certain time on all the transmissions of the network “RaiUno” switch from the 2D format to the “3D side by side L/R” format. In such a case, the device 200 would continue to acquire and supply a wrong coding and transport configuration, because it would not be aware that the format has changed. A similar problem might arise in another possible situation, wherein a particular program or group of programs or video contents coming from a certain television broadcaster have a different format than the remaining programs. For example, it may happen that the program “La domenica sportiva” is broadcast by RaiTre in the “L+Depth” 3D format, whereas the remaining programs keep the “side by side” 3D format.

It is therefore advantageous, at least for certain types of video stream sources (e.g. television), to verify that the configuration data acquired from the memory area of the device are correct starting from the video stream itself, in an autonomous manner and, as far as possible, without involving the user. Should it turn out from this verification that the coding and transport configuration corresponds to the acquired one, no operations will be carried out; if this should not be the case, the device 200 will output the coding and transport configuration resulting from the configuration data obtained from the video stream, which, when present, will have priority over those previously acquired and stored in the memory or memory area 12, since they are likely more up-to-date than the latter.

FIG. 7 illustrates in detail the method for verifying the correctness of the data relating to the coding and transport configuration acquired by the storage means 12. If this verification is activated (block START 500), the device 200 executes (block 510) the step of obtaining the coding and transport configuration of the video stream selected by the user, for example, starting from metadata contained in the selected video stream or on the basis of the analysis of the video content thereof. At step 520, it is verified if the coding and transport configuration acquired from the storage means 12 for the selected video stream corresponds to that contained in the same. In the affirmative case, the process ends (block STOP 550); otherwise, the association between the identification data of the selected video stream and the respective coding and transport configuration is suitably stored into the storage means 12 (block 530).

Said association will be different from the one(s) previously present in the storage means 12 for that specific video stream, because it identifies a video content of the selected stream having a configuration conflicting with that or those previously associated with the stream. Block 540 acquires and outputs the coding and transport configuration obtained from the selected video stream, which replaces the one previously applied to the block 470 of FIG. 6 for reproducing the video stream on the associated reproduction device 5. At this point the process ends.

The above-described verification process can be repeated not only when a video stream is selected by the user, but also any time a change is possible in the transport configuration for the video stream selected for reproduction.

Typically, for video streams belonging to television services this occurs, for example, when the programs broadcast by the television broadcasters are changed. This is made possible by the presence, in the video stream contained in an MPEG transport stream in accordance with the DVB standard, of Event Information Tables (EIT) that contain information about the current and future programs of digital television services (of the DVB type) contained in an MPEG 2 transport stream. In this way, any video contents of a television service having a coding and transport configuration which differs from the one previously stored for the video stream of that service can be immediately detected and stored into the storage means 12.

The correctness of the configuration data can be verified by the device 200 by verifying the presence of metadata relating to its own coding and transport configuration. These metadata may be associated or not with the particular program being broadcast. When the broadcaster transmits the data relating to the transport configuration in use in association with the programs using them, it is possible to store into the storage means 12, as data identifying the video stream, for example, the name or code of the television service, the LCN code thereof, or any other data that identifies a television service or at least the video stream thereof, along with the programs that use a certain transport configuration.

This may advantageously be done, for example, only for those programs whose transport configuration differs from that of the majority of programs, so that there will be a default configuration that will be applied to a video stream belonging to a given service unless the program being broadcast is included in those having a discordant configuration. This is useful for saving memory and for not having to store one association for all the programs belonging to a television service that uses at least two coding and transport configurations. For example, let us assume that broadcaster “RaiTre” broadcasts all programs in 2D except “La domenica sportiva”, which uses the “L+depth” 3D format. Initially the storage means 12 of the device contain, as a coding and transport configuration, a datum that corresponds to “no 3D format”, i.e. “2D” format.

Since this is independent of the program being broadcast, only one association is stored for the service RaiTre between the service identifier of RaiTre and the coding and transport configuration “2D”. After receiving the first episode of the program “La domenica sportiva”, whose transport configuration is “L+depth”, during the verification procedure of FIG. 7 the device 200 adds into the storage means 12 the association between the stream identifier, consisting of a combination of the service identifier “RaiTre” and the program name “La domenica sportiva”, and the configuration “L+depth”. Since the next program (e.g. “TG3”) returns to the 2D format, the device does not store a new association between the identifier (“RaiTre”+“TG3”) and the configuration “2D format”, because there is already an association between “RaiTre” and “2D format”, which must therefore be intended as the “default” association valid for RaiTre programs, i.e. for all RaiTre programs for which there is no specific association in the memory 12, i.e. comprising a program title (see FIG. 5).

For those broadcasters that include in the video stream the information about the coding and transport configuration of each television program being broadcast, the correction method executed by the device 200 may comprise storing, as a stream identifier, the pair (service identifier, program title) or even, if sufficient to ensure a univocal identification, only the program title. This is possible because the MPEG standard includes EIT tables that contain the program titles, so that it is sufficient to enter a private datum denoting the coding and transport configuration used for broadcasting that specific program.

The storage means 12 may even contain a real EPG (Electronic Program Guide), to which the coding and transport configuration used by the broadcaster for broadcasting the program is added, if available.

As an alternative or in addition, the presence and correctness of the coding and transport configuration can be verified (blocks 430 in FIGS. 6 and 510 in FIG. 7, respectively) by analyzing the video content of the selected video stream, by using any algorithm suitable for detecting such a configuration. This analysis can be conducted by a suitable hardware or software module included in the video processing apparatus 300 (not shown in FIGS. 1 and 2), or the video content may be forwarded to a device capable of analyzing it and extrapolating from it, through appropriate algorithms, the coding and transport configuration.

Should for any reason the association stored in the storage means 12 and obtained through the above-described method be wrong, i.e. when the “no 3D configuration” is associated with a 3D video stream, typically the video stream is represented on a display device associated with the video processing apparatus 300 as if it were in 2D format, i.e. two-dimensional. The user can thus detect a wrong visualization of the video stream on the display device 5 and, through the control unit 6, send through a sixth output 14 a control signal signalling a wrong visualization due to a wrong or outdated association contained in the storage means 12. Upon receiving the control signal, the control module 9 operates in accordance with a first association and storage procedure in order to acquire from the user the correct configuration to be associated with the identification datum corresponding to the video stream being displayed on the display device 5.

In the first association and storage procedure, the control module 9 requests to the video processor 15, through the second output 13, to operate in the second operating mode already described, i.e. to enter a graphic interface into the images that make up the video stream; in particular, the graphic interface contains a request, addressed to the user, to enter the coding and transport configuration of the currently selected video stream. The user then enters the coding and transport configuration through the control unit 6; the corresponding user control signal is then sent to the control module 9 through the sixth output 14 of the control unit 6.

In order to save memory space, it can be advantageous to assume that a video stream identifier which is not included in the data structure of FIG. 3 is in 2D format by default. The control module 9 of the device can monitor with a predetermined frequency (e.g. every 1 or 2 seconds) the presence of identifiers in the video stream being represented on the display device 5. When a change in the identification data is detected (e.g. a change in the program number, service, transmission, transmission frequency channel, video stream input port, file name, volume name and/or title of a DVD or Blu-ray disk, etc.), the control module 9 performs a scan of the associations stored in the memory to verify which coding and transport configuration is associated with the video stream identification datum, and outputs the corresponding configuration datum in accordance with the flow chart shown in FIG. 6. If the configuration datum is not retrieved from the selected video stream, the control module 9 assumes that the stream has a 2D configuration, and therefore treats the video stream as an ordinary two-dimensional video stream, outputting a signal indicating that it is a 2D video stream. The associated display apparatus 21 may cause the video stream to be represented on the connected display device 5 as if it were two-dimensional, i.e. without applying any visualization adaptation mechanism to the input video stream in order to obtain the three-dimensional effect.

An example of associations stored in the storage means 12 is shown in FIG. 3. In this example, the television broadcaster or service “RaiUno” (and/or the frequency channel number and/or the program number under which said service is stored) is associated with the coding and transport configuration of the “Side by side” type. Therefore, every time the video stream “RaiUno” (and/or the corresponding frequency channel and/or program number) is selected, the control module 9 will output the configuration associated therewith, which will be transmitted to the display apparatus 21 to ensure a correct reproduction of the three-dimensional content. The same considerations apply to the service “RaiDue”. In the cases of “RaiUno” and “RaiDue”, it is assumed that the entire program schedule has three-dimensional contents. On the contrary, if only a few programs utilize 3D contents, the video stream will be identified through the service identifier. The table of FIG. 5 shows the example of “RaiTre”, with the program identifier “La domenica sportiva”. The module 9 will thus output the “L+Depth” configuration only when the service “RaiTre” transmits the program “La domenica sportiva”.

A different case, still related to television services, arises when the majority of the streams being broadcast has a first three-dimensional configuration (e.g. of the “side by side R/L” type for the service “RaiSatCinema”) and only a few single events or programs have a different second configuration (e.g. of the “Top-bottom” type for the movie “Il ritorno dello Jedi”, still being broadcast by “RaiSatCinema”). In this situation, therefore, every time the video stream “RaiSatCinema” is selected the control module 9 will output the associated configuration indicating the “side by side” type, except when on this service the movie “Il ritorno dello Jedi” is broadcast, for which the output will provide the associated configuration indicating the “Top-bottom” type. For three-dimensional contents coming from television broadcasters, it is possible to associate a coding and transport configuration for the images contained in the three-dimensional video stream not only with a service identification code (e.g. the LCN code indicating the service in the DVB-T standard), but also with a code identifying the program being broadcast (e.g. in the DVB-T standard, the EIT tables transmitted in the MPEG-2 coding and transport stream contain information that identifies the program). In this manner, a coding and transport configuration can be automatically associated directly with a television program, not only with a service.

In the last two rows of the table of FIG. 3 there is an example of association which applies to the case wherein the video contents are stored in a storage medium. In such a case, the three-dimensional video stream is identified through the path of the file from which the 3D content is being received: in order to ensure an absolutely univocal identification, it is also possible to store the file size, date and time by means of a CRC32 or Hash code obtained from the file content. Different types of association may also be conceived, as in the case of television broadcasters, e.g. by associating a file, identified by its file path, with a configuration type.

In FIG. 3, the file “C:\Filmati3D\vacanze01.mkv” is associated with the coding and transport configuration “L+depth”. A second type of association associates all files coming from a specific folder or path with a certain configuration type. For example, in FIG. 3 the files contained in the directory “C:\Filmati3D”, except “vacanze01.mkv”, which has already been associated with the “Side by side” configuration, are associated with the “Top Bottom L/R” configuration.

It is apparent that the data structure of FIG. 3 may contain, in addition to the service or file name and to the program title, also the program number and/or the video stream input port, which may contribute to ensuring a univocal identification.

Of course, the data structure of FIG. 3 may possibly also comprise information indicating that a given video stream is two-dimensional and therefore must be treated by the display apparatus 21 differently from the three-dimensional video streams.

The association list described in FIG. 3 actually represents the data structure present in the storage means 12. It can be physically implemented in different forms known to those skilled in the art. For example, it may be implemented as a look-up table, i.e. a data structure in table form which associates two or more groups of homogeneous data. This data structure allows associating a corresponding output data set with each admissible combination of input data.

In the present description, the input data are the data identifying a given video stream, corresponding to output data consisting of the coding and transport configuration of said given video stream.

In an alternative implementation, it is conceivable that a list of configuration data relating to the possible configurations is stored in a certain memory area of the storage means 12, and that the output of said look-up table does not correspond directly to the configuration, but to a pointer indicating the memory cell that contains the configuration datum included in said list and corresponding to the identified video stream. Such a modified data structure is illustrated in FIG. 4. With this alternative it is no longer necessary to replicate multiple times the configuration data in the look-up table in the event that the same coding and transport configuration data correspond to multiple identification data (e.g. all RaiTre programs except “La domenica sportiva”). In order to remove, modify or add an association in the list, it is sufficient that the control module 9 executes removal, modification or entry operations on the look-up table elements corresponding to that specific association. This also applies to the case wherein the output of the look-up table is a memory cell pointer: in such a case there will be no need to modify the memory cells containing the configuration data.

As an alternative to the pointer table shown in FIG. 4, it is possible to use a pointer list wherein each element has two pointer fields: the first one points at the next element in the list, while the second one points at the configuration associated with the stream identification data. This latter data structure has the advantage of saving more memory space, in that those memory locations which contain stream identifiers that have become obsolete because they have not been detected for a long time, i.e. for a time longer than a predetermined threshold value, can be made available again easily.

It is also conceivable that the video stream identification data are grouped and stored into specific memory spaces, and that the control module 9 assigns a specific configuration to each one of said memory spaces. In this case, in order to remove, modify or add associations it is sufficient that the control module 9 removes, moves or enters the identification data from/into the corresponding memory spaces. It should also be pointed out that the association list may, without distinction, contain either the video stream identification datum or any code referable to said datum in a form known to the control module 9. A similar consideration also applies to the image coding and transport configuration data.

It is also conceivable that a predetermined memory space is allocated for storing the associations, so that, when this space is reached and exceeded, the control module 9 cleans the memory by removing the associations corresponding to those identifiers whose video streams were detected at an excessively remote time instant. To this end, the data structure in which the associations were made may be provided with a data field (not shown) which is updated each time by the control module 9, said field indicating the last date and time that the video stream was detected. One may also provide that some particularly important streams cannot be deleted, such as, for example, those corresponding to the video streams coming from television broadcasters saved in the program table. In order to avoid using computational resources of the control module 9 during the normal operation of the apparatus 300, the cleaning operation may be carried out when the apparatus is in stand-by mode.

It is also conceivable that this operation is carried out when the memory space occupied by the associations exceeds a certain predetermined threshold.

It is also advantageous that, when the apparatus 300 is installed, updated or reinstalled and the program table is generated, the processing device 200 allocates a part of said table to the associations between broadcaster identifiers (broadcaster name or code, which in this case constitute the video stream identification data) and the respective configuration data.

In a preferred embodiment of the invention, during the procedure for installing or reinstalling or updating the program table of the apparatus 100, the processing device 200 automatically attempts to associate with the video stream the respective coding and transport configuration that characterizes it, in accordance with at least one possible automatic procedure, i.e. chosen among all those procedures which do not require a manual action by the user. This can be done by applying the method shown in FIG. 6 to all television services received during the scanning step, wherein the streams selected by the user for reproduction are replaced by video streams of television services just found and tuned to on a television channel. Of course, in such a case the storage means 12 may be initially empty and may be progressively filled with data relating to the video streams found during the channel scan. In this case as well, one can use, as methods for detecting the configuration of the video streams, the presence of metadata or the analysis of the decoded video content of the stream. In both cases, if said identifier is detected or deduced with sufficient confidence, it will be automatically associated with the video stream. These two automatic procedures may be implemented together or separately in the same processing device 200, depending on the design choices made by the manufacturer. This minimizes the risk that no association is found in the memory 12 which corresponds to the video stream selected by the user in the memory 12 in the course of the ordinary operating life of the video processing apparatus, i.e. the risk of a negative result of the verification carried out at block 420 of FIG. 6.

Likewise, every time any video stream Fᵢ is selected which originates from any source Sᵢ not included in the program table (e.g. a file in a USB memory or an optical disk of a multimedia reader), the processing device 200 of the present invention may automatically carry out the same method of FIG. 6 to save the user from having to manually re-enter the configuration of the video stream, if this was already done during a previous selection of the same stream.

In the event than none of the available automatic procedures is successful, it is advantageous that the processing device 200 offers the user the possibility of manually entering the configuration data, at least for those video streams (whether or not stored in the program table) whose value cannot be recognized automatically. For example, at the end of the programming, re-programming or program update procedure, the processing device 200 may ask the user to manually enter the configuration data of the respective video streams of the television broadcasters stored in the table, by using the above-mentioned interactive dialogue method.

The associations stored in the storage means 12, used by the control module 9 for automatically associating three-dimensional streams with image coding and transport configurations, may be defined in various ways; for example, they may be stored into the storage means 12 at the factory on the basis of, for example, information supplied by three-dimensional video content providers, or they may be defined and redefined by the user.

In particular, it is conceivable that the manufacturer enters into an area of the storage means 12 a set of associations between video stream identifiers and coding and transport configurations which can be used as an initial table subject to application of the method shown in FIG. 6. These associations may concern those video streams which will most likely be selected by the user in the course of the operating life of the video processing apparatus, i.e. typically video streams belonging to television services, whose configurations are known a priori.

It is also conceivable that the associations defined at the factory can be subsequently modified by the user, or that the user can add new ones. In the present description, the expression “to define an association” means to enter a new association into the association list. Conversely, “to redefine an association” means, in a first case, to change the value of at least one of the two components of the association, i.e. the configuration datum and the identification datum, or, in a second case, to remove the association itself from the data structure (table or list) that contains it.

Associations can be defined or redefined by the user with several options. For instance, a first option is the use of the association and storage procedures previously described. A second option may give the user access to the entire association list: in this way, the user can define or redefine multiple associations by means of a single procedure. By using the control unit 6, the user can issue through the sixth output 14 an association list modification request command; in response to said command, the control module 9 reads, through the data exchange line 11, the data structure representing the list from the storage means 12. Then the control module 9, through the second output 13, sends to the video processor 15 a request for entering into the video stream being displayed a graphic interface that allows the user to modify the entire association list. Said list may be an integral part of the program table that contains all the stored television services with the associated tuning information. Finally the user, through the control unit 6, can issue one or more commands adapted to modify the association list: in response to these commands, the control module 9 updates the data structure contained in the storage means 12 through the data exchange line 11.

It is also conceivable that, in order to help the user, the graphic interface displaying said list also enumerates the identifiers of those video streams not yet associated with any specific coding and transport stream, such as, for example, a graphic interface containing a complete list of the television broadcasters included in the program table generally present in the apparatus 300. The term “program table” refers to a table or list containing an association between the program numbers selectable by the user through the control unit 6 and the radio-television broadcasters that the apparatus 300 can possibly be tuned to, independently of the source and of the coding and transport means employed for their distribution. Said program table may be contained in the storage means 12 or in a separate memory area (not shown in the drawings). In this way, the user can define new associations for multiple video streams not currently selected for display.

As an alternative, it is possible to transmit to the control module 9 and/or to the storage means 12 a software update, which may also be periodical, containing information about said associations. The software update may be automatically downloaded, for example, if one of the sources Sᵢ is an Internet interface; when a source Sᵢ is a DVB signal tuner, it may be transmitted over a radio broadcasting channel or another distribution network (e.g. Internet). Once extracted from the decoder 1, the software update is sent to the control module 9 through the input 10. Of course, hybrid solutions may also be conceived, which make a combined use of two or more of the above-described possibilities.

The layout of the functional elements described above and illustrated in FIG. 1 and FIG. 2 is wholly exemplary and constitutes a simple block diagram representing one embodiment of the device according to the present invention.

It is apparent that two or more functional blocks may be implemented into a single hardware device, and that a single functional block may be implemented through collaboration of two physically separate circuit elements (e.g. a video recorder, a set top box, a television set, a monitor). Thus, for example, it may happen that in the future two or more functional blocks among the video processor 15 and/or the control module 9 and/or the decoder 1 and/or the data interface control unit 23 are integrated into a single integrated circuit, which nonetheless clearly includes hardware or software modules implementing the invention described herein.

In particular, the memory 12, also referred to, without distinction, as memory area or storage means, may without distinction consist of one or more separate modules, consist of one or more volatile or non-volatile parts, comprise parts external or internal to the device 200 and/or the apparatus 300, with no effect whatsoever upon the present invention.

In turn, the control module 9 may be implemented by means of the microprocessor that normally controls the operation of a video reproduction device or apparatus adapted to implement the present invention. It may be implemented in programmed-logic software or hardware form, or as a special circuit.

It is apparent that the present invention is also applicable to the case wherein the acquisition and storage device is associated or associable with a video recording device, instead of a video reproduction device or apparatus. This device may be integrated into the same apparatus or may be associated therewith through a suitable connection interface, whether wired (e.g. HDMI, DVI, Display port, Ethernet) or wireless (e.g. Wi-Fi, WLAN).

It is important to underline that the present invention proves advantageous also in the case wherein the 3D player device can recognize the configuration of the 3D video stream, in that the adopted mechanism may be subject to delays or defects which may be difficult or impossible to overcome. For example, if an image analysis system is employed for obtaining the video stream configuration, said analysis may be very complicated, since it generally demands complex computational processing activities that require much computational power and take quite a long time.

When the configuration is recognized with the help of special metadata entered into the video stream (which technique can be adopted for both back-compatible types), it may happen that the metadata are not recognized due to transmission errors or that they are recognized with a delay because, for example, they are not transmitted frequently enough. In this case, the associated configuration data storage according to the present invention allows making considerably faster the identification of the video configuration and the consequent adaptation of the display apparatus when the tuned program number is changed (especially when the newly selected program belongs to a different mux than the one currently tuned to), or when the configuration changes within the same program at the transition from one transmission to the other, without having to wait for the acquisition of the related metadata contained in the video stream to be reproduced, which might not arrive in time.

Similar considerations apply to the fast identification of a generic three-dimensional video stream acquired from a solid-state optical or electronic mass medium associated with the reproduction device, e.g. obtained from an Internet site, recorded from a television program, or directly recorded by a private video camera.

The values of the coding and transport configurations mentioned in this description and indicated in the tables and in the other data structures shown in the figures are wholly exemplary and symbolic. They may consist of any data, code or data set based on which the device 200 and/or the apparatus 300 can determine which configuration is associated with a given video stream. These data may also comprise other configuration features, such as the degree and mode of undersampling of the original stereoscopic images that make up the composite frame, without however departing from the protection scope of the present patent.

Also, in the present description reference has been made to three-dimensional vision based mainly on stereoscopic images, i.e. starting from two distinct images. It is apparent that the present invention is also applicable to the so-called multidimensional or “multiview” systems, wherein the perception of scene three-dimensionality is produced by a number of views of the same scene greater than two.

It can therefore be easily understood that what has been described herein may be subject to many modifications, improvements or replacements of equivalent parts and elements without departing from the novelty spirit of the inventive idea, as clearly specified in the following claims.

1. A method for acquiring and storing data relating to video streams (Fᵢ) selectable on a video processing apparatus adapted to select a video stream reproducible on an associated reproduction device, said method comprising the steps of:
identifying the source of the video stream by means of identification data, said video stream having a coding and transport configuration adapted to produce a three-dimensional display;
verifying if, for the identified video stream, any data relating to the coding and transport configuration of said video stream have been stored by said video processing apparatus in storage means of said video processing apparatus comprising associations between video stream identification data and video stream coding and transport configurations;
in the affirmative case, acquiring from said storage means the coding and transport configuration associated with the video stream identified by said identification data, and
using the data relating to the acquired coding and transport configuration for a following selection of said video stream in order to reproduce the selected video stream on an associated video reproduction device.

2. A method according to claim 1, comprising the further steps of:
obtaining, from the video stream selected for display, data relating to its coding and transport configuration;
if the attempt is successful, verifying if the data relating to the obtained coding and transport configuration of said video stream correspond to those stored in said storage means, and
if the attempt is unsuccessful, using the data relating to the coding and transport configuration acquired from the video stream for video reproduction on said device.

3. A method according to claim 1, wherein at least a portion of said associations is established by using a data structure stored in said storage means by the manufacturer of said video processing apparatus.

4. A method according to claim 1, wherein at least a portion of said associations is defined or redefined through a software update.

5. A method according to claim 1, wherein said data relating to the coding and transport configuration are included in one or more pieces of metadata associated with said video stream.

6. A method according to claim 1, wherein said data relating to the coding and transport configuration are obtained by analyzing at least a portion of the decoded video content of the three-dimensional video stream to be identified.

7. A method according to claim 1, wherein said at least one identification datum comprises information data identifying a television broadcaster.

8. A method according to claim 7, wherein said at least one identification datum comprises information identifying a television program broadcast by said television broadcaster.

9. A method according to claim 1, wherein said data relating to the coding and transport configuration can be manually entered by the user through a control unit associated with said video processing apparatus.

10. A method according to claim 1, wherein said associations may be defined or redefined by the user of said apparatus.

11. A method according to claim 1, wherein said association is represented in table form as a univocal association between said at least one identification datum and said configuration datum contained in a second data structure of a plurality of coding and transport configurations, said second data structure being stored in said storage means.

12. A method according to claim 1, wherein said association is represented as a pointer between said at least one identification datum and said configuration datum contained in a second data structure of a plurality of coding and transport configurations, said second data structure being stored in said storage means.

13. A video stream processing apparatus adapted to generate a video stream which can be reproduced by a display device, said processing apparatus comprising means for implementing the method according to claim 1.

14. An apparatus according to claim 13, wherein said configuration datum is outputted through a data interface.

15. An apparatus according to claim 13, comprising means for processing a video signal, capable of entering into said reproducible video stream a piece of information associated with said configuration datum in a graphic form that can be recognized by the user.

16. An apparatus according to claim 13, wherein said processing apparatus incorporates said display device.
